(19) United States
(12) Patent Application Publication
(10) Pub. No.: US 2014/0156501 A1
(43) Pub. Date: Jun. 5, 2014

(54) REAL-TIME INTERACTIVE CREDIT SCORE IMPROVEMENT COACH

(71) Applicant: MASTERCARD INTERNATIONAL INCORPORATED, Purchase, NY (US)

(72) Inventor: Justin Xavier Howe, Oakdale, NY (US)

(73) Assignee: MASTERCARD INTERNATIONAL INCORPORATED, Purchase, NY (US)

(21) Appl. No.: 13/693,730

(22) Filed: Dec. 4, 2012

(51) Int. Cl. G06Q 40/02

(52) U.S. Cl. CPC G06Q 40/025
USPC 705/38

(57) ABSTRACT

A method and system for providing a credit coaching service for providing real-time recommendations to improve a credit score for a user retrieves credit report data issued from a credit reporting agency for analysis by a processor and initializes datafeeds for accessing in real-time financial transactions by the user from at least one financial source. Corrective actions are determined and alerts transmitted in real-time to the user in response to detection of a real-time financial transaction that adversely affects the user's credit score.

### FIELD OF THE INVENTION

The present invention relates to systems and methods for monitoring and improving one's credit score and, more particularly, to a system and method for real-time correlation of a consumer's credit and debit behavior to the consumer's credit score.

### BACKGROUND OF THE INVENTION

It is common knowledge that having a high credit score is key to a consumer's ability to qualify for and benefit from low interest rate mortgages, loans, and credit cards. Surprisingly, however, most consumers do not have a good understanding of how one's credit score is obtained, or what factors influence a credit score in both a negative and positive way. Most likely, this is, in part, a result of an unwillingness to invest the time and effort to learn more about how one can improve his or her credit score. Also, it is certainly not always easy to find the correct tools, resources, or advisors to effectively improve one's credit score. Doing so requires a certain amount or perseverance and continued investigation, particularly when credit rating agencies constantly change their methodologies.

It is clear that many consumers need assistance with managing their finances. For example, a report dated April 2003 report from the Consumer Federation of America and the National Consumer Law Center estimated that nearly 9 million people in financial trouble contacted credit counseling organizations annually. IRS inventory records listed 788 approved tax-exempt credit counseling organizations as of November 2005, and revenue reported for Tax Year 2000 for this tax-exempt industry was approximately $1 billion. Clearly, consumers have a need for assistance and education in improving their credit scores

There are a number of internet-based resources available for obtaining periodic (monthly) updates of one's credit score. Such services are available, for example, on Quizzle.com and Credit Karma. These and similar sites rely on monthly updates of credit file information obtained from credit reporting agencies (CRAs). Since CRAs receive this information once a month from the banks, however, they cannot provide real-time responses that allow a consumer to directly and immediately correlate one's actions or account activity with one's credit score.

Having the knowledge of how one's credit score is determined is just a first step. One must also recognize how to integrate that knowledge into one's daily spending habits. This is particularly difficult without the benefit of some type of feedback correlated with one's activities. Without the availability of real-time credit data, a corrective real-time response is unlikely if not impossible.

There are, of course, general recommendations which cardholders can implement to improve their credit scores. For example, cardholders can usually set up an automatic payment for their debt payments, or register to receive reminders. There are other more subtle influences on one's credit score, however, that neither a bank, nor any currently available internet-based service, can provide alerts for. For example, notification mechanisms do not exist for factors that drive good credit scores, such as percentage of credit line utilized, or the debt-to-income ratio.

At the most, some credit score providers provide pre-generated bullet point messages with recommendations about how a consumer can improve one's credit score, but are otherwise unhelpful on a personal interactive level. Such general recommendations may include: “Reduce your balance”; “Pay your bill every month”; and “You need a longer credit history.”

To be more useful and relevant, credit improvement recommendations are needed that incorporate more about a particular cardholder's financial activity than can be gleaned from a report that is only updated monthly. Furthermore, cardholders need to know the cause of credit score increases or decreases over time in order to modify their behavior.

There is, therefore, a need in the art for a method and system for real-time correlation of a consumer's behavior to a credit score and for providing real-time alerts of credit score triggers to allow a consumer to understand and correct his or her financial behavior in real-time.

### SUMMARY OF THE INVENTION

The present invention provides a method and system for real-time correlation of a consumer's behavior to a credit score and for providing real-time alerts of credit score triggers to allow a consumer to understand and correct his or her financial behavior in real-time.

A method is provided for providing a credit coaching service for providing real-time recommendations to improve a credit score for a user includes retrieving credit report data issued from a credit reporting agency; accessing in real-time financial transactions by the user from a datastream from at least one financial source; and determining a corrective action by the processor in response to one of the real-time financial transactions by the user that adversely affects the credit score for the user. Preferably, an alert comprising the corrective action is transmitted to the user in response.

In various aspects, the alerts can be communicated as one or more of an SMS text message, a smartphone alert, a robo-dialed telephone call, an e-mail, and a listing accessible to the user via a website link to the credit coaching service.

In an additional aspect, the real-time financial transactions can include at least one of credit card transactions, debit card transactions, installment loan payments, checking account transactions, PIN debit/signature transactions, ATM card transactions, chip card transactions, smart card transactions, Near-Field Communication transactions and smartphone transactions.

In yet another aspect, the method can include maintaining a prioritized queue of recommended credit behaviors. The method preferably focuses on a highest priority behaviors in the queue. If a credit transaction is detected that adversely affects the user's credit score, the corrective action that is determined in response is directed to furthering the highest priority credit behavior in the queue.

Likewise, if a debit transaction is detected that adversely affects the user's credit score, the corrective action that is determined in response is directed to furthering the highest priority debit behavior in the queue.

In various aspects, in response to a consistent demonstration over a predetermined period of time of the highest priority behavior in the queue by the user, the credit behavior queue and/or debit behavior queue is reprioritized.

In a preferred aspect, the method includes continuously recalculating the user's credit score in response to each real-time financial transaction.

In an additional aspect, the method further includes calculating a plurality of performance metrics affecting the credit score from the real-time financial transactions, periodically retrieving updated credit reports, and providing a historical timeline of the calculated credit scores and plurality of credit score parameters, which can be displayed on a graphical user interface.

In various aspects, the performance metrics can include one or more of Debt-To-Income ratio, credit line utilization, number of transactions, and growth in savings or debits.

A system is also provided for providing a credit coaching service for providing real-time recommendations to improve a credit score for a user. The system includes a data interface periodically retrieving credit report data issued from a credit reporting agency and accessing in real-time financial transactions by the user over a datastream from at least one financial source; a database operatively connected to the data interface, the database receiving and storing the credit report data and real-time financial transactions; and a processor operatively connected to the database retrieving and analyzing the credit report data and real-time financial transactions, calculating the credit score for the user, and determining a corrective action in response to one of the real-time financial transactions adversely affecting the credit score for the user.

Preferably, an alert comprising the corrective action is transmitted to the user in response.

In one aspect, the real-time financial transactions include at least one of credit card transactions, debit card transactions, installment loan payments, checking account transactions, PIN debit/signature transactions, ATM card transactions, chip card transactions, smart card transactions, Near-Field Communication transactions and smartphone transactions.

A computer readable medium storing instructions is also provided that when executed by a processing device, cause the processing device to provide real-time recommendations to improve a credit score for a user by retrieving credit report data issued from a credit reporting agency, accessing in real-time financial transactions by the user from a datastream from at least one financial source, determining a corrective action in response to one of the real-time financial transactions by the user adversely affecting the credit score for the user, and transmitting an alert comprising the corrective action to the user.

In one aspect, the computer readable medium can include one of a chip card, a smart card, a Near-Field Communication card, and a smartphone.

In addition to the above aspects of the present invention, additional aspects, objects, features and advantages will be apparent from the embodiments presented in the following description and in connection with the accompanying drawings.

### BRIEF DESCRIPTION OF THE DRAWINGS

FIG. 1 is a schematic representation of an embodiment of a system of the present disclosure.

FIG. 2 is a flow chart representation of a first phase of an embodiment of a method of the present disclosure.

FIG. 3 is a flow chart representation of a second phase of the embodiment of the method of FIG. 2, including providing real-time alerts to a user in response to a financial transaction.

### DETAILED DESCRIPTION OF EMBODIMENTS

The following sections describe exemplary embodiments of the present invention. It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto.

The present invention is directed to a method and system for providing users a real-time, interactive instructional and informational service for understanding how one's payment card use and other debit and credit behavior can affect one's credit score. The method and system of the present invention provide real-time alerts of credit score triggers to both allow the cardholder to understand the effects of his or her credit-related behavior, and to correct his or her behavior, if needed, in real-time.

A “payment card” as used herein includes a credit card, a debit card (signature or PIN), an ATM card, a CHIP card or a smart card, including a Near-Field Communication (NFC) card, as well-as other NFC forms of payment such as fob NFC or smartphone NFC.

“Payment card data” can include authorization and clearing data.

The steps of the various embodiments of the methods of the present invention are implemented via computer software or executable instructions or code, which can be stored in any appropriate type of computer readable medium for access and execution by a processor for performing the method steps described herein.

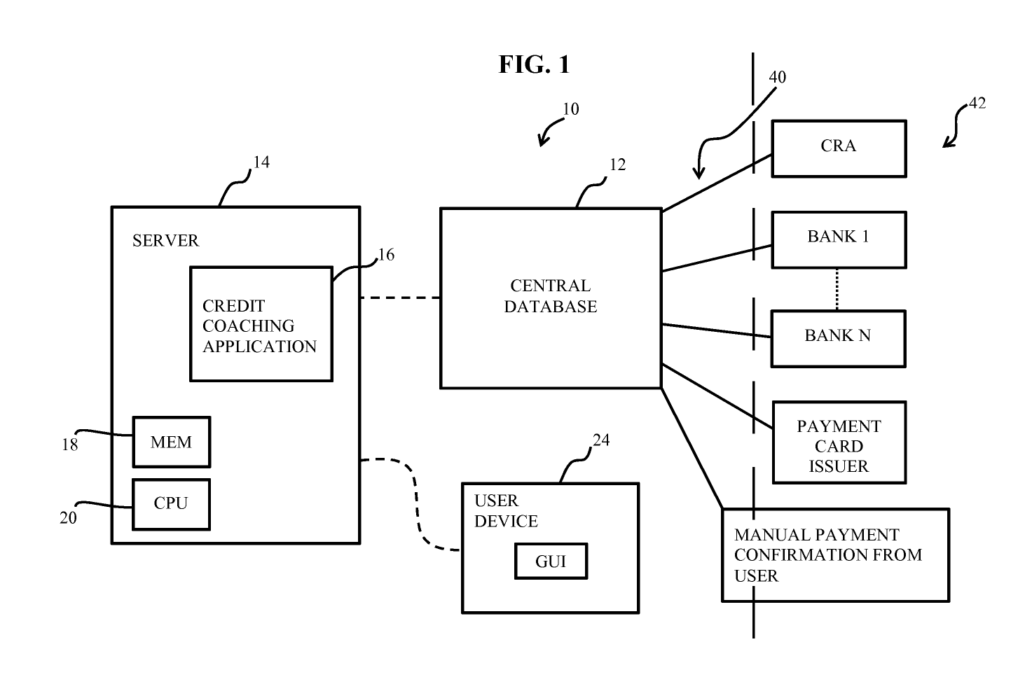

Referring to FIG. 1, one embodiment 10 of a system of the present invention includes at least a central database 12 operably connected to a server 14 hosting a credit coaching service 16. The server 14 includes memory including a computer readable memory 18, and a processor 20 for executing method steps, which are stored in the computer readable memory 18. The central database 12 is accessible by the processor for storing and making available to the processor consumer's profiles, credit reports, credit and debit events, and so on as described herein. A user can also access various tools offered by the credit-coaching service remotely via a website link to the server, or can download the tools, for example, over the Internet in the form of a smartphone app, for viewing on a display 22 on the user's smartphone, computer, or other user-operated device 24.

One of skill in the art will appreciate that the instructions stored on the computer readable memory 18 are accessible by the processor 20, which preferably includes a central processing unit (CPU), and that when executed causes the processor 20 to implement the steps of the methods described herein. The memory 18 can include any combination of random access memory (RAM), read only memory (ROM), a storage device including a hard drive, or a portable, removable computer readable medium, such as a compact disk (CD) or a flash memory, or a combination thereof. The computer executable instructions for implementing the methods of the present invention may be stored in any one type of memory associated with the server 14, or additionally or alternatively distributed between other various types of memory devices in user-operated devices, including in a payment card, such as a chip card, smart card, or smartphone, and if necessary, loaded into RAM or flash memory, for example, upon execution.

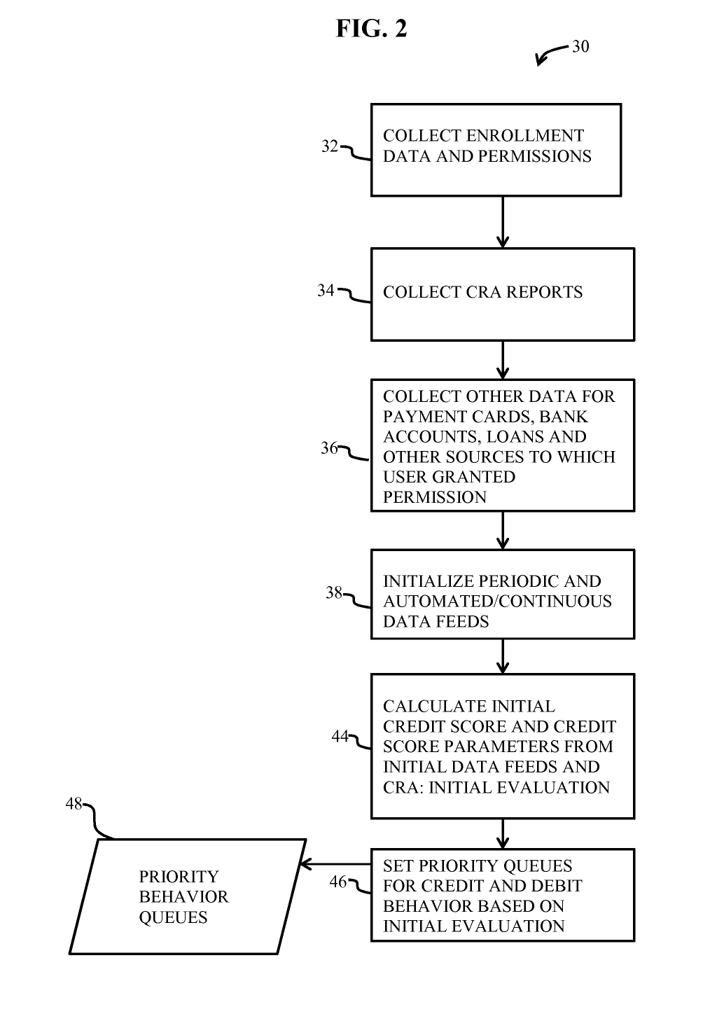

Referring to FIG. 2, in one embodiment of a method of the present invention 30, an enrollment process 32 is initiated by each user, for example, via a web-based enrollment form. The user is prompted to provide basic identification information needed for identification and login validation, including name, address, social security number and email address. The user also grants permissions, and provides the pertinent information, to allow access to the user's credit reports from a Credit Reporting Agency (CRA) and to other credit and debit information the user elects to be monitored, such as detailed banking transactions. If the user grants permission to monitor checking accounts, the user is preferably requested to submit the routing and transit number on the bottom of a check. From this information, debit card numbers or demand deposit account (DDA), or checking account, information can be collected.

The user's social security number (SSN) is preferably collected during the enrollment process, as it is generally required to access credit reports. A SSN also provides an additional validation of identity. It is contemplated that other types of personal identification numbers, such as driver's license serial number and so on, may also be sufficient. In addition, if access is granted to credit cards, both the credit card numbers and the CVC2 numbers are preferably collected. The CVC2 number provides another validation of identity, implying possession of the card.

During the enrollment process, each user preferably elects a preferred means, or multiple means of communication, by which he or she wishes to receive communications and alerts. Users can elect to receive communications, for example, via one or more of the following methods: SMS text messages; smartphone alerts; robo-dialed telephone calls; or e-mail. Alternatively, or additionally, all alerts and communications directed to a user can be retrieved by that user by logging in to the service 16 and viewing their latest notifications, along with a history of their notifications, all of which are preferably stored in the central database 12.

In addition to enrolling in the service by logging on to a web-site, in other embodiments, users can enroll in the service when registering with a credit bureau to request one-time or periodic credit reports, or when applying for a credit card or other payment card or line of credit. Of course, any suitable means can be used to enroll a user in the service, including offering a telephone number which the user can call to communicate the enrollment information for input into the system.

In another embodiment, in which the credit coaching service and tools are accessed via an app downloaded to a smartphone, the enrollment process can alternatively begin with an initial login to the service through the downloaded app. In this embodiment, the enrollment process preferably requires agreement by the user that credit reports and card transaction details may be accessed for any account numbers or social security numbers entered. Next the cardholder enters the identification and verification information, including name, address, email address, phone number, SSN, and at least one credit card number along with the corresponding CVC2 number. Users can supplement this enrollment information further with DDA information using the app or through the website at their leisure.

User profiles containing the particulars provided during the enrollment process can be stored in the central database 12.

Once enrollment is complete, in accordance with the permissions granted by a user 32, credit data in the form of a most recent report, and optionally, prior reports, from a CRA is collected 34 for the user. In addition, any data related to credit cards, debit cards, bank accounts, loans, and any other information to which the user has granted access is also collected for a period of time, preferably of at least a month, prior to a user's enrollment 36.

Referring to FIG. 2, once the initial available CRA reports, and credit and debit data is collected for a user, data feeds 40 are also initiated 38 for collecting debit, credit, DDA and other transactions as they occur in real-time. Such data is preferably stored in the central database 12. For example, any of the following datastreams 40 may be gathered by the server 14 over the Internet from various sources for users who have granted the necessary permissions and stored in the database 12 as follows:
Datastream A: A monthly feed of CRA data, including mortgage, student and car loan balances.
Datastream B: A real-time data feed from the CRA of credit inquiries, and newly granted credit lines.
Datastream C: A real-time data feed of DDA (checking account) data, to be provided by the depository bank or payment network, including PIN enabled transactions as well as signature debit transactions.
Datastream D: A real-time data feed of ATM withdrawal data, if DDA access was granted by the cardholder, to be provided by the depository bank or payment network.
Datastream E: A real-time data feed of payment card spend data for each open account, as provided by the issuing bank or the payment network.
Datastream F: Periodic information from credit agencies, banking institutions, and so on reporting any changes that could affect the calculation of credit scores.

In addition to the real-time data available from banks regarding debit and credit card charges, DDA debits and so on, in various embodiments of the method of the present invention, bill payments can be made through the credit-coaching service 16 accessed either from one's smartphone through an app or remotely via a web site link. Accordingly, an additional datastream can include real-time data feed of bill payments made through the app or website. The system and method of the present invention also preferably provide the option for such bill payments not included in any automated datastream to be manually reported by the user, in order to provide the most complete and current payment information possible. Such information can also be used by the CRA to update credit report information, or as advance notice by the credit coaching service or user to a creditor that payment is en route.

Referring to FIG. 1 and FIG. 2, the data collected from the datafeeds from the various data sources 42 are used to calculate initial values for each user for credit score factors 44 such as a total credit line, a percentage of credit line utilized, balances paid, income, debit card expenditures and ATM withdrawals as percentages of income, for example, and so on. In addition, an initial credit score calculation and initial evaluation is performed for each user and stored in the database 12 along with the other historical, real-time, and profile data for the user.

Still referring to FIG. 2, to provide both educational information and corrective recommendations, a queue of behaviors 48 for both credit and debit behavior specific to each user is provided and maintained 46 in the database 12, with a highest priority behavior being emphasized until changes are detected in the user's behavior.

The queue of behaviors is a ranking of recommended behaviors to be communicated to a user based on past history. A ranking of recommended credit behaviors for a particular user who has enrolled in the service without a credit card may be prioritized, for example, after the initial evaluation, as follows:
(1) Own a credit card. Since a credit card is not owned, the method may include directing the user to a retailer that issues cards.
(2) Pay off balances monthly. Ideally, pay off balances more than once monthly.
(3) Use less than 35% of the credit limit.
(4) Own more than one credit line.
(5) Have both an installment credit line and a revolving credit line in one's credit history.

Additional credit behaviors in the queue could include, but are not limited to:
Make charges AND payments on each credit line each month, to add to credit history.
Setup direct withdrawals.
To improve expense tracking, try to put more transactions on cards.

A ranking of recommended debit behaviors for a particular user may be prioritized, for example, as follows:
(1) Avoid incurring overdraft fees.
(2) Avoid taking cash out of ATMs where you must pay fees.
(3) Avoid impulse purchases.

Additional debit behaviors in the queue could include, but are not limited to:
Make a budget, and stick to it.
Save toward large purchases, rather than buying them on credit.
Save some money with each paycheck.
To improve expense tracking, try to put more transactions on cards.

A listing of recommendations 54 is also maintained in the central database 12, preferably in a table listing each of the prioritized behaviors, users' potential negative or positive credit or debit events related to the prioritized behavior, and a listing of the corresponding appropriate recommendations 54 for including in a message communicated to the user in response to the credit or debit events.

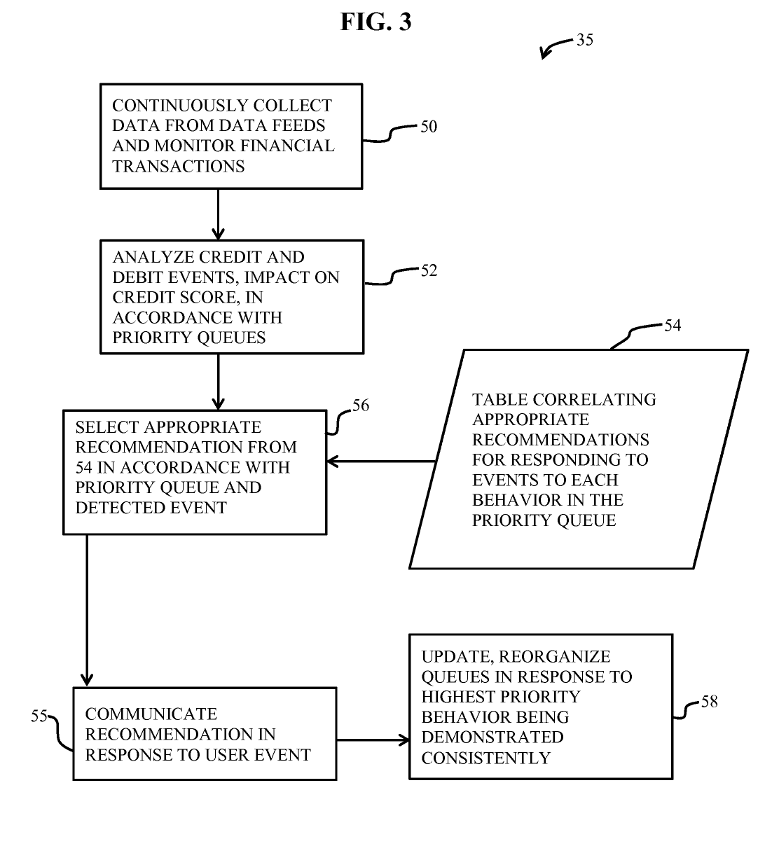

Referring to FIG. 3, in a real-time corrective phase 35, a user's behavior is continuously monitored and real-time feedback provided with corrective recommendations as warranted, upon receipt of details of a financial transaction. Preferably, details of a particular financial transaction are transmitted in real-time from one of the data sources 42. Data is continuously collected from the various data sources 42 after the initial values for each user are calculated for credit score factors 44, and these calculated values are continuously updated as new data is received, and are used as key indicators of potential credit score increases or decreases at the end of each month. Such indicators are the percentage of credit lines utilized during the current month, a number of credit lines with activity, or inactivity, during the current month, a number of credit lines with payments in the current month, a last maximum account balance, and so on.

Still referring to FIG. 3, the method of the present invention includes continuously monitoring the datafeeds for real-time indications of user behavior 50, such as purchases, payments, pay-offs of principal balances, opening and closing of credit lines, and analyzing the particular behavior for its relevance to the highest priority item in the debit and credit recommendation queues. Appropriate recommendation(s) are then selected 56 from the table 54 in accordance with the priority recommendation queues and the particular user behavior, and communicated to the user 55 in response to such events, preferably in real-time. This allows the user the opportunity to immediately correct any negative behavior and to better understand the relationship between various behaviors and one's credit score.

Examples of recommendations communicated in response to credit behavior include, for example:
“Your credit balance has been zero for a month. You can raise your credit score by making a small purchase (i.e. coffee) and paying it off immediately. You should do this every month.”
“You have not reported a monthly payment. 50% of cardholders pay their balance every month and it is required if you want a high credit score.”
“You registered this app with a debit card. Debit cards are useful for spend management, but they cannot improve your credit score. Please add a credit card number to this account.”
“Your only line of credit is your credit card. Take out a small installment loan to increase your credit score.”
“Setup an automatic monthly withdrawal to pay your minimum credit card amount. You can always make an extra payment.”
“You have only one line of credit and it is your credit card. Getting another card and maintaining a zero balance will raise your credit score.”
“You just damaged your credit score by exceeding your last ‘maximum’ balance. To avoid reducing your score further, pay down on your credit cards to reduce your balance as soon as possible.”
“We noticed that you just bought a house. Please note that your credit score will now change because you will be compared against other homeowners. We will keep you updated when we know more.”
“We noticed that you just bought a car on credit. Taking out your first installment loan can improve your credit score, but it will take some time for us to update your statistics because you will now be compared against other car loanees.”
“We noticed there has been no activity on your credit card in the last three months. Charge your next purchase and make timely payments on your credit card to raise your credit score.”

Examples of recommendations communicated in response to debit behavior include, for example:
“Avoid bringing your checking account balance to zero.”
“We recommend that you use some of your savings to pay down your credit card balance. It will save you $50 dollars a month, and it will improve your credit score.”

Once a highest prioritized behavior is exhibited by a user over a predetermined period of time, the behavior queues for that user are reorganized and updated 58, with the second highest priority behavior being reordered as the highest priority behavior, and so on.

The central database 12 maintains a record for each user of the current list of prioritized behaviors, as well as a history of a user's credit and debit behaviors, and continuously updates the calculated credit score. Preferably, embodiments of the method of the present invention includes displaying this information in various forms, including in tabulated list form, and in more easily visualized graphs and reports.

It will be appreciated to those of skill in the art that the calculated credit score is an estimate of one's credit score based on the information made available at the time.

For example, a Score Card can be provided for display on a user's graphical user interface (GUI) in the form of a dashboard display, by organizing the display of the multiple sources of information related to the various accounts of a user into an easily understandable, and, preferably, interactive format.

The Score Card provides an intuitive visualization of performance that is quickly understood, and is particularly useful as a financial education tool. The Score Card display can include graphic visualization of statistics, calculated from data imported to the database 12, for example, according to various embodiments of the present invention. For example, the Score Card can organize and display visual representations of statistics mapped on the same timeline in dashboard format, so that the effect of each user action on the user's credit score is readily apparent. For example, the dashboard can simultaneously show over a period of time chosen by the user for display, for example, over a week, two weeks, a month, six months, or a year or more, any one or more of the following:
trending in a user's credit card utilization as it varies by day (or over larger time, depending on period of time displayed) with a graphic line of the target for optimal credit score;
trending over same period of time of a user's credit score;
trending in the balances of a user's accounts by day, or week, month, six months;
large purchases (above a certain predetermined threshold) on credit not immediately paid off can be marked with a graphic, and comments or legends could clearly indicate that these are instances where pre-saving would have been better;
mark with an icon, for example, the date of any credit inquiries;
flag any periods of time where credit card utilization is over a particular threshold, such as 35% of the credit limit
indicate time periods where money is saved, which can include paying down loan interest and principal, by color coding in green, for example, and periods where money is overspent in yellow, for example;
trending in estimated annual interest expense over time;
growth in savings, investments, and debt over time;
trending in debt-to-income ratio (the ratio of total debt payments per month to total monthly income);
pay-offs of credit cards and other debts

Accordingly, the credit and debit information is organized and displayed in a form which quickly educates the user as to what behaviors have negative and positive effects on one's credit score.

In various embodiments, the dashboard can also be interactive, and can include links, for example, that allow the user to pay a bill or credit card, for example, to lower usage to no more than 35% of a card limit, open a credit card, apply for an installment loan, or take other corrective actions suggested for improving one's credit score.

In various additional embodiments, the dashboard containing actual statistics of the user's data can also be provided in a simulated interactive format. In so doing, the user can click on various “links” that simulate the user paying down credit cards, opening a credit card or installment loan, or taking any other simulated credit or debit action. In response, the simulated dashboard is updated to show the projected effect that such actions, if actually taken by the user, would have on the user's credit score.

The tools for generating the dashboard or Score Cards on a GUI can be hosted on the server 14 and accessed remotely via a website link, or can be downloaded to a user's computer or to a smartphone, tablet or other user device, for example, in the form of an app.

In various additional embodiments of the methods of the present invention, badges and/or points can be awarded to users who obtain certain benchmarks for demonstrating good financial habits and to incentivize continued good financial behavior. Examples of badges that can be awarded and displayed on one's dashboard, for example, include: credit improver (earned for signing up); credit card owner; maintains balance (in one's checking account for emergencies); below 35% (utilization of total credit lines); installment credit owner; homeowner; habitual saver; good budgeter; overdraft fee avoider; and so on.

In certain embodiments, a computer readable product is provided, which includes any computer readable medium or memory product known in the art, which stores computer executable instructions or program code that when executed by a processor on a user-operated device perform the method steps described herein to obtain the user's credit and debit history and real-time actions either directly from datafeeds 40, or from a central database 12 collecting the datafeeds, and to analyze and provide real-time recommendations to improve one's credit score based thereon. Such user-operated devices can include a smartphone, computer product, tablet, smartphone wallet credit card, and so on. It should be recognized that the components illustrated in FIG. 1 are exemplary only, and that it is contemplated that the methods described herein may be implemented by various combinations of distributed hardware, software, firmware, circuitry, and/or processors and associated memory, for example, as well as other components known to those of ordinary skill in the art.

### Example of a User's Experience

A cardholder signs up for a credit card with a credit coaching service of the present invention included, completing the required enrollment form and granting the necessary permissions. While waiting for the new credit card to arrive, the user logs in remotely to the service via a website link to see an initial evaluation based on the credit report and any additional data submitted with, or immediately accessible for download, upon enrollment. In this example, the user owned a store-affiliated credit card at the time of enrollment so there is already some credit history, and badges are awarded as a credit improver and credit card owner. The user downloads the associated credit coaching app to the user's smartphone via the website link.

The cardholder can then click on a ‘Priorities’ section of the website, for a complete list of ways the user can improve her credit. There are several behavioral points that are listed in prioritized order, with the recommended focus being on one highest priority item: Staying below 35% utilization of the user's total credit line. This behavior is primarily flagged as highest priority because of the newly opened credit card. However, if the user continues to pay her bill on time, especially with the additional second card, this goal is hopefully quickly achieved and the behavioral list reprioritized.

Next the cardholder clicks on a ‘Dashboard’ section of the site, where she can see a visualization of her credit score, history, and various factors affecting her credit score, such as credit card spend behavior, over a period of time. In this case, the user chooses to view any data available over the past 2 years. The dashboard shows certain other statistics related to debit card and checking account behavior that are grayed-out, because she hasn't signed up for these credit products (either she does not have any or has not granted the requisite permissions). In this case, the user has a debit card, and so clicks on a link available via the Dashboard to incorporate her debit account information.

After typing in her debit card number and the numbers at the bottom of her checking account, the site adds several more badges to her profile such as: Overdraft Fee Avoider and Habitual Saver. Her dashboard has also updated so that the checking account content is no longer grayed out, and there are a few more recommendations, including that she should save in advance of large purchases rather than buy on credit. The service provides the option of listing the specific items she wishes to purchase, and of monitoring their cost over time to automatically notify her of deals. The service can also provide other purchase planning tools, including links to a bank through which a savings account can be opened, and automatically setting aside money on a periodic basis.

Two days later, she is out shopping when she receives an alert on her smartphone with the following message: “Please use the app to verify you've paid your credit card bill this month. If not, you can pay your minimum payment through the app with one-click.”

A week later she is reminded that she is using 50% of her available credit line, and that reducing it to 35% will improve her credit score. She receives these reminders on a weekly basis, and immediately after any atypical purchases or large purchases, which eventually gets her down to 35% credit line utilization. After staying below 35% credit line utilization for two months, she is awarded a new badge and sees new priorities on her dashboard, “Take out a small line of installment credit.”

It will be appreciated that the present invention has been described herein with reference to certain preferred or exemplary embodiments. The preferred or exemplary embodiments described herein may be modified, changed, added to or deviated from without departing from the intent, spirit and scope of the present invention, and it is intended that all such additions, modifications, amendments and/or deviations be included in the scope of the present invention.

What is claimed is:

1. A method for providing a credit coaching service for providing real-time recommendations to improve a credit score for a user, the method comprising:
retrieving credit report data issued from a credit reporting agency;
accessing in real-time financial transactions by the user from a datastream from at least one financial source; and
determining a corrective action by the processor in response to one of the real-time financial transactions by the user that adversely affects the credit score for the user.

2. The method of claim 1, further comprising transmitting an alert comprising the corrective action to the user.

3. The method of claim 2, wherein the alert is communicated as one or more of an SMS text message, a smartphone alert, a robo-dialed telephone call, an e-mail, and a listing accessible to the user via a website link to the credit coaching service.

4. The method of claim 1, wherein the real-time financial transactions include at least one of credit card transactions, debit card transactions, installment loan payments, checking account transactions, PIN debit/signature transactions, ATM card transactions, chip card transactions, smart card transactions, Near-Field Communication transactions and smartphone transactions.

5. The method of claim 1, further comprising maintaining a prioritized queue of recommended credit behaviors, wherein in response to the one of the real-time financial transactions being a credit transaction that adversely affects the credit score, the determined corrective action is directed to furthering a highest priority credit behavior in the queue.

6. The method of claim 5, further comprising maintaining a prioritized queue of recommended debit behaviors, wherein in response to the one of the real-time financial transactions being a debit transaction that adversely affects the credit score, the determined corrective action is directed to furthering a highest priority debit behavior in the queue.

7. The method of claim 6, further comprising continuously monitoring the real-time financial transactions, analyzing the effect of each of the real-time financial transactions as it is accessed on the credit score; and
reprioritizing at least one of the prioritized queue of credit behavior and the prioritized queue of debit behavior in response to the real-time financial transactions monitored over a predetermined period of time favorably affecting the credit score in accordance with at least one of the highest priority credit behavior and highest priority debit behavior.

8. The method of claim 7, further comprising continuously recalculating the credit score in response to each real-time financial transaction.

9. The method of claim 8, further comprising calculating a plurality of performance metrics affecting the credit score from the real-time financial transactions, periodically retrieving updated credit reports, and displaying a historical timeline of the calculated credit scores and plurality of credit score parameters.

10. The method of claim 9, wherein the performance metrics comprise one or more of Debt-To-Income ratio, credit line utilization, number of transactions, and growth in savings or debits.

11. A system for providing a credit coaching service for providing real-time recommendations to improve a credit score for a user, the system comprising:
a data interface periodically retrieving credit report data issued from a credit reporting agency and accessing in real-time financial transactions by the user over a datastream from at least one financial source;
a database operatively connected to the data interface, the database receiving and storing the credit report data and real-time financial transactions; and
a processor operatively connected to the database retrieving and analyzing the credit report data and real-time financial transactions, calculating the credit score for the user, and determining a corrective action in response to one of the real-time financial transactions adversely affecting the credit score for the user.

12. The system of claim 11, wherein the processor transmits an alert comprising the corrective action to the user.

13. The system of claim 11, wherein the alert is communicated as one or more of an SMS text message, a smartphone alert, a robo-dialed telephone call, an e-mail, and a listing accessible to the user via a website link to the credit coaching service.

14. The system of claim 11, wherein the real-time financial transactions include at least one of credit card transactions, debit card transactions, installment loan payments, checking account transactions, PIN debit/signature transactions, ATM card transactions, chip card transactions, smart card transactions, Near-Field Communication transactions and smartphone transactions.

15. The system of claim 11, the database further storing a prioritized queue of recommended credit behaviors, wherein in response to the one of the real-time financial transactions being a credit transaction that adversely affects the credit score, the corrective action is directed to furthering a highest priority credit behavior in the queue.

16. The system of claim 15, the database further storing a prioritized queue of recommended debit behaviors, wherein in response to the one of the real-time financial transactions being a debit transaction that adversely affects the credit score, corrective action is directed to furthering a highest priority debit behavior in the queue.

17. The system of claim 16, the processor continuously monitoring the real-time financial transactions, analyzing the effect of each of the real-time financial transactions as it is accessed on the credit score, and reprioritizing at least one of the prioritized queue of credit behavior and the prioritized queue of debit behavior in response to the real-time financial transactions monitored over a predetermined period of time favorably affecting the credit score in accordance with at least one of the highest priority credit behavior and highest priority debit behavior.

18. The system of claim 17, the processor continuously recalculating the credit score in response to each real-time financial transaction.

19. The system of claim 18, further comprising a graphical user interface operatively connected to the processor, the processor calculating a plurality of performance metrics affecting the credit score from the real-time financial transactions, periodically retrieving updated credit reports, and providing a historical timeline of the calculated credit scores and plurality of credit score parameters to the graphical user interface.

20. A computer readable medium storing instructions that when executed by a processing device, cause the processing device to provide real-time recommendations to improve a credit score for a user by retrieving credit report data issued from a credit reporting agency, accessing in real-time financial transactions by the user from a datastream from at least one financial source, determining a corrective action in response to one of the real-time financial transactions by the user adversely affecting the credit score for the user, and transmitting an alert comprising the corrective action to the user.

21. The computer readable medium of claim 20, comprising one of a chip card, a smart card, a Near-Field Communication card, and a smartphone.
